(19) United States
(12) Patent Application Publication
(10) Pub. No.: US 2003/0010519 A1
(43) Pub. Date: Jan. 16, 2003

(54) Wraparound seal for optical fibers

(76) Inventor: Amandus Pieck, Kortenaken (BE)

Correspondence Address: MYERS BIGEL SIBLEY & SAJOVEC, PO BOX 37428, RALEIGH, NC, 27627, US

(21) Appl. No.: 10/182,938

(22) PCT Filed: Feb. 8, 2001
(86) PCT No.: PCT/GB01/00485

(30) Foreign Application Priority Data
Feb. 11, 2000 (GB) 0003073.4

(51) Int. Cl. H02G 3/18

(52) U.S. Cl. 174/65 R

(57) ABSTRACT

A seal member (1) for a cable feed-through device (10) comprises a body having at least one axially extending opening (2) for accommodating a cable (9), and a radially extending slot (3) connecting the at least one opening (2) with an outer surface of the body. The body is made of compressible material such as rubber, so as to provide a sealing of the cables when radial pressure is applied. The material of the body has a Shore “A” hardness in a range between 15 and 55.

The present invention relates to a wraparound seal for optical fibres. More in particular, the present invention relates to seal member for a cable feed-through device, the seal member comprising a body having at least one axially extending opening for accommodating an optical fibre cable and a substantially radially extending slot connecting the at least one opening with an outer surface of the body. Such a seal member is known from European Patent Application EP 0 580 130 (Ichikoh Industries).

Cable feed-through devices are generally used to guide cables through an opening in a wall while preventing the ingress of any dirt or moisture. To this end, the device is provided with a seal member, for example a so-called grommet, which may be made of rubber. The above-mentioned European Patent Application EP 0 580 130 discloses a rubber grommet.

To obtain a proper moisture seal the cables need to tightly fit in the through openings in the seal member. In addition, sufficient pressure must be applied to seal the seal member against the inserted cables. When the cables are optical fibre cables applying pressure may result in transmission losses, which obviously is highly undesirable. Especially in the case of single fibre cables the amount of pressure which can be applied on the cables without incurring transmission losses is very limited. In particular, a concentration of pressure one one particular spot of the optical fibre cable should be avoided.

International Patent Application WO 97/42693 (Raychem) discloses a different kind of seal member. In this known seal member the pressure distribution problem is solved by accommodating the cables between an inner and an outer ring of relatively soft sealing material which are axially compressed by two pressure planes such that the rings convert the axial pressure into radial pressure. Although this known seal member is very effective, it consists of many parts and is relatively time-consuming to install. In addition it is not truly wraparound.

In addition, the seal member of the kind defined in the preamble is provided with a predetermined number of openings or through-holes for accommodating cables (it will be understood that the term “cables” as used in this document is meant to encompass single optical fibres, multiple optical fibres, guide tubes for optical fibres, so-called “pigtails” and “jumpers” and the like). However, if the number of cables to be accommodated is less than the number of openings, it will be necessary to insert a plug into each unused opening to provide sealing. To provide a secure sealing both a plug and a sealing material have to be inserted into each unused opening. This makes the conventional optical fibre cable feed-through device labour-intensive and therefore relatively expensive to install.

The present invention seeks to overcome these and other problems of the Prior Art and to provide a wraparound seal member for a cable feed-through device which is simple and economical to install.

The present invention further seeks to provide a wraparound seal member for a cable feed-through device which is economical to manufacture.

The present invention also seeks to provide an economical and ready to install sealing feed-through device for optical fibres cables.

To these and other ends a seal member as defined in the preamble is according to the present invention characterised in that the body is made of compressible material having a Shore “A” hardness in a range between 15 and 55. This allows the seal member to be mounted in the feed-through device under some pressure resulting, due to the compressible nature of the material, in the walls of the openings being pressed against the inserted cables without causing excessive local pressure. Thus no sealant is required and a good seal is obtained. In addition, any unused holes may be pressed closed, removing the need for the insertion of separate plugs or stops. As a result, a very simple and quick yet sealing installation of the feed-through device is possible.

It will be understood that the said material is non-porous and watertight. Particularly suitable materials are elastomers, such as natural and synthetic rubber. However, some soft plastics may also be used, or other materials which are resiliently flexible. The seal member is preferably compressed in its radial direction.

In order to allow a suitable amount of compressability the material of the body advantageously has a Shore “A” hardness in a range between 15 and 55. The inventor has found that this range provides a good sealing without the risk of damaging the relatively fragile optical fibres. It is noted that this range is surprisingly low when compared with e.g. normal rubber, which has a Shore “A” hardness of approximately 70.

Preferably, the material of the body has a Shore “A” hardness in a range between 20 and 45. In particular, “A” values of approximately 20 to 25 are suitable, especially of approximately 25, but other values are also possible.

The number of openings in the body of the seal member is preferably six, although other numbers of openings are also possible. Each slot preferably has substantially parallel walls, making it easy to provide a good sealing of the slot when the seal member is compressed.

The present invention further provides a feed-through device for optical fibre cables comprising a housing and a seal member provided with at least one axially extending opening for accommodating cables, characterised in that the seal member is made of a compressible material having a Shore “A” hardness in a range between 15 and 55, and in that the housing is arranged for radially compressing the seal member.

The housing may constitute a so-called gland. The compressing may be effected by a nut enclosing the housing. In such an embodiment, the housing is preferably tapered and is on its outside provided with a screw thread for engaging the nut.

The present invention will further be explained with reference to the accompanying drawings in which:

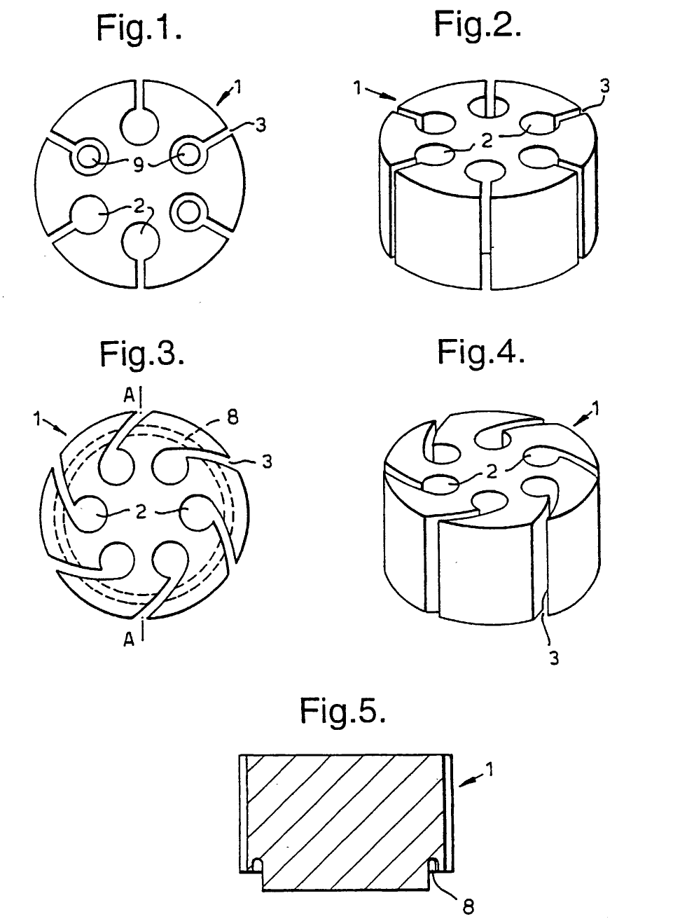

FIG. 1 is a plan view of a first embodiment of a seal member of the present invention.

FIG. 2 is a perspective view of the seal member of FIG. 1.

FIG. 3 is a plan view of a second embodiment of a seal member of the present invention.

FIG. 4 is a perspective view of the seal member of FIG. 3.

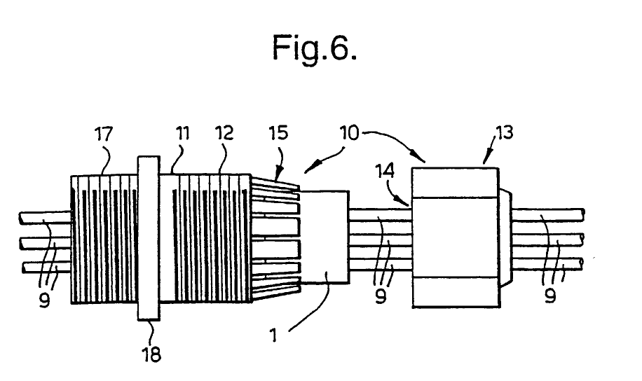

FIG. 5 is a cross-sectional view taken along the line A-A in FIG. 4.

FIG. 6 is a schematic plan view of a cable feed-through device provided with the seal member of FIG. 1.

The seal member 1 shown merely by way of example in FIG. 1 comprises a cylindrical body having openings or through-boles 2 extending in the body's axial direction. In the examples shown, six openings 2 are provided but other numbers of openings such as one, two, three, four or eight, can also be envisaged.

The openings 2 serve to accommodate optical fibre cables 9, such as so-called “pigtails”. The dimensions of the seal member 1 and the of the openings 2 depend on the particular cables to be accommodated. It has been found that even pigtails having a diameter of 4 mm can be effectively sealed, provided a suitable material having a suitable hardness is used. The inventor has found that elastomers, such as rubber, are particularly suitable provided they have a Shore (A-scale) hardness between about 15 and 55. In particular materials having a Shore “A” hardness of about 20 to 30 have been found advantageous, a most preferred Shore “A” hardness value being 25.

Slots 3 connect the openings 2 and the outer surface (circumference) of the seal member. The slots 3 serve to allow cables to be inserted into the openings in the radial rather than the axial direction of the body. This so-called “wrap-around” feature facilitates cable installation. As can be seen in FIG. 1, the slots 3 are narrower than the openings 2 so as to provide a better sealing action upon compression. This is also shown in FIG. 2, where the seal member 1 is shown without the cables. The compression applied is preferably radial rather than axial. By decreasing the circumference of the seal member the openings 2 and slots 3 are pressed tight, resulting in a good seal.

The seal member 1 of FIGS. 3 and 4 also comprises a substantially cylindrical body having openings 2 and slots 3. In this embodiment, however, the slots 3 do not extend merely radially and are generally spirally shaped. This spiral shape provides an even better sealing as the slots are more easily closed under radial pressure.

A groove 8, also shown in FIG. 5, may accept a circular protrusion of a housing (not shown), thus assisting the positioning of the seal member within the housing.

The cable feed-through device 10 shown in FIG. 6 comprises a housing 11 provided with an external screw thread 12 and a cap or nut 13 provided with an internal screw thread 14 so as to engage screw thread 12 and press the cap 13 onto the housing 11. To provide appropriate compression of the seal member 1 the housing 11 has at one end a tapered portion constituted by approximately axially extending tabs or compression lips 15. When mounting the cap 13 onto the housing 11 the flexible tabs 15 are pressed against the seal member 1, thus causing compression of the seal member and a sealing of the openings. In this way, a good sealing is achieved using a minimum of components and effort.

The device 10 shown in FIG. 6 can be used to feed cables (i.e. pigtails) into an enclosure (not shown). The additional external screw thread 17 can be engaged by the internal screw thread of an additional nut (not shown) pressing the radially extending rim 18 of the housing 11 against a wall through which the device 10 and the cables 9 pass. The device 10 of FIG. 6 can also be used as a cable termination, a larger cable entering the device 10 from the left (in FIG. 6) and several smaller cables leaving the device 10 at the right. Also in the latter case a simple yet effective sealing is achieved.

It will be understood by those skilled in the art that the present invention is not limited to the embodiments shown and that many additions and modifications are possible without departing from the scope of the present invention as defined in the appending claims.

1. A seal member (1) for a cable feed-through device (10), the seal member comprising a body having at least one axially extending opening (2) for accommodating an optical fibre cable (9), and a substantially radially extending slot (3) connecting the at least one opening with an outer surface of the body,
characterised in that the body is made of compressible material having a Shore “A” hardness in a range between 15and 55.

2. A seal member according to claim 1, wherein the material of the body has a Shore “A” hardness in a range between 20 and 45, preferably between 20 and 30.

3. A seal member according to claim 1 or 2, wherein the compressible material is an elastomer such as rubber.

4. A seal member according to any preceding claim, wherein the number of openings (2) equals six.

5. A seal member according to any preceding claim, wherein the slots (3) extend substantially spirally from the openings (2).

6. A seal member according to any preceding claim, wherein each slot (3) has substantially parallel walls.

7. A cable feed-through device (10) for optical fibre cables (9), comprising a housing (11); and
a seal member (1) provided with at least one axially extending opening (2) for accommodating cables,
characterised in that the seal member (1) is made of a compressible material having a Shore “A” hardness in a range between 15 and 55, and in that the housing (11) is arranged for radially compressing the seal member.

8. A feed-through device according to claim 7, wherein the housing (11) has a tapered portion and is on its outside surface provided with a screw thread (12) for engaging the nut (13).

9. A feed-through device according to claim 8, wherein the housing (11) is provided with axially extending flexible lips (15) for compressing the seal member (1) when applying the nut (13).
